(19) United States
(12) Patent Application Publication
(10) Pub. No.: US 2013/0181657 A1
(43) Pub. Date: Jul. 18, 2013

(54) DEVICE FOR CHARGING OF RECHARGEABLE BATTERIES

(71) Applicant: Didrik Eidsvig, Sandvika (NO)

(72) Inventor: Didrik Eidsvig, Sandvika (NO)

(73) Assignee: DEFA AS AUTOMOTIVE DIVISION

(21) Appl. No.: 13/821,339

(22) PCT Filed: Sep. 13, 2011
(86) PCT No.: PCT/NO2011/000245

§ 371 Date: Mar. 7, 2013

(30) Foreign Application Priority Data
Sep. 13, 2010 (NO) 20101286

(51) Int. Cl. H02J 7/00

(52) U.S. Cl. CPC H02J 7/0003
USPC 320/106; 320/110

(57) ABSTRACT

Present invention relates to a device (1) for charging of rechargeable batteries, comprising a house (2) with a transformer, cable (3) with a plug (4) for mains input, cables (5, 6) for supplying electric power to the battery, clamping devices (7, 8) for connection to the poles of a battery, switch (11) for activation and deactivation of the charging device (1) and at least one visual indicator (12) to give the user an indication of the charging progress, said house (2) has such a design that the cables (3,5,6) and the plug (4) are completely or partially situated in the house (2), and the clamping devices (7, 8) are attached to holding means (9, 10) which protrude from the house (2), said holding means (9, 10) comprise two protruding elements, said cables (5, 6) for are winded around the circumference of the house (2) between each of the protruding elements of respective holding means.

The present invention relates to a charging device for charging of lead batteries and other rechargeable battery types. The invention relates in particular to so called “domestic chargers” which can be used especially for the charging of lead batteries for vehicles.

Many different types of devices for charging of lead batteries and other batteries are known. What is common for many of these chargers is that the charging device is fitted with a long row of buttons/switches, where the user is faced with a number of choices that must be made to start the charging process. Furthermore, a well known problem with many chargers is that sparks are generated when making the connection to the battery. Another problem is that the cable ends, both for connection to the battery and to the mains, are not easily handled in a simple and sensible way when the product shall be tidied away and be stored after use.

Therefore, the inventor has provided a charging device where focus is given to the user and to the ease of operation. The charging device is characterised in that a simple, clean and, functional design which takes into consideration that the connection cables are coiled and fastened to the product housing. The coiling and fastening steps are integrated in a new and innovative way. The user only needs to uncoil the cables and then to connect the crocodile clamps to the battery and make the connection to the mains. Thereafter the charging is initiated by pushing the on/off button. This will be regarded as very safe as the user is not exposed to unnecessary sparks and the like in the connection process. The charger will itself detect and adjust the charging process according to the size of the battery and the surrounding temperature. During charging and after completion of the charging the indicator on the charger will, at any time, give the status of the charging. The charging will finish on its own or in that the user presses stop to terminate.

For this purpose a software program is developed that is adapted to a charging process for batteries of any size and condition. In addition, attention is given to a simple, clear and, not least, user-friendly interface with the help of the on/off button of the unit and the display.

The form of the charging device and the mechanical design of its components are very demanding as both the mains cable and the battery cables are easily coiled round after use and fastened to the product so that these are firmly secured during storage. Both the clamps and the mains plug are fastened to the housing. These considerations mean that special adaptations are made on the electronic components and the edb board.

It has also been an assumption that in the design a compact unit is made with corresponding layout and choice of components so that the unit is as small as possible. This means that the heat loss through the housing of the product has been a critical parameter. The collaboration between electronics and mechanics is carried out in such a way that it does not lead to overheating of the electronic parts.

In addition, some extra equipment for connecting has been developed. For this purpose a watertight plug that can be taken out and inserted again is formed on the battery cable. This gives the possibility of connection of the additional equipment that, among other things, comprises cables with eyelet terminals and a plug to the battery charger. This means that the user can fit a series of permanent cables, with a corresponding plug on the batteries, to a part of the motorised equipment that requires regular charging. The charger can then be easily transported from location to location to carry out the charging job. A small, removable battery indicator is also developed that can be connected to this equipment to indicate whether a battery needs charging or not.

These, and other aims and advantages are achieved with a charging device for charging of lead batteries and other rechargeable battery types, encompassing a housing with a transformer, cable with a plug for connection to the mains, cables for supply of electric power to the battery, clamping means for connection to the poles of a battery, a switch for the activation and deactivation of the charging device and at least one visual indicator to give the user an indication of the charging progress, characterised in that the housing has a shape so that the cables and the plug are completely, or partly, lying in the housing and the clamping devices are fastened to the holding means that protrudes from the housing, when the device is not in use, as each holding means comprises two protruding elements, that the cables for the connection of the battery are coiled around the circumference of the housing between each of the protruding elements of the respective holding means.

The cable for connection to the mains is preferably coiled around the periphery of the housing and the plug is preferably placed in a recess in the housing when the device is not in use.

The paths of the coiling of the cable with the plug and the cables for connection to the battery are preferably, in the main, in parallel and axially displaced in relation to each other.

Furthermore, the device preferably comprises an electronic unit that measures/senses which type of battery that is to be charged, the surrounding temperature and the battery capacity.

The electronic unit preferably controls the charging voltage and the charging process as a function of the measured parameters.

The device comprises an indicator that gives the user a visual indication of the charging process.

The charging device is preferably adapted to charging open and closed lead batteries, AMG batteries and gel batteries with a capacity of 4-225 Ah.

The indicator preferably comprises at least one LED.

The invention will now be explained in more detail with the help of an embodiment example with reference to the enclosed figures, where:

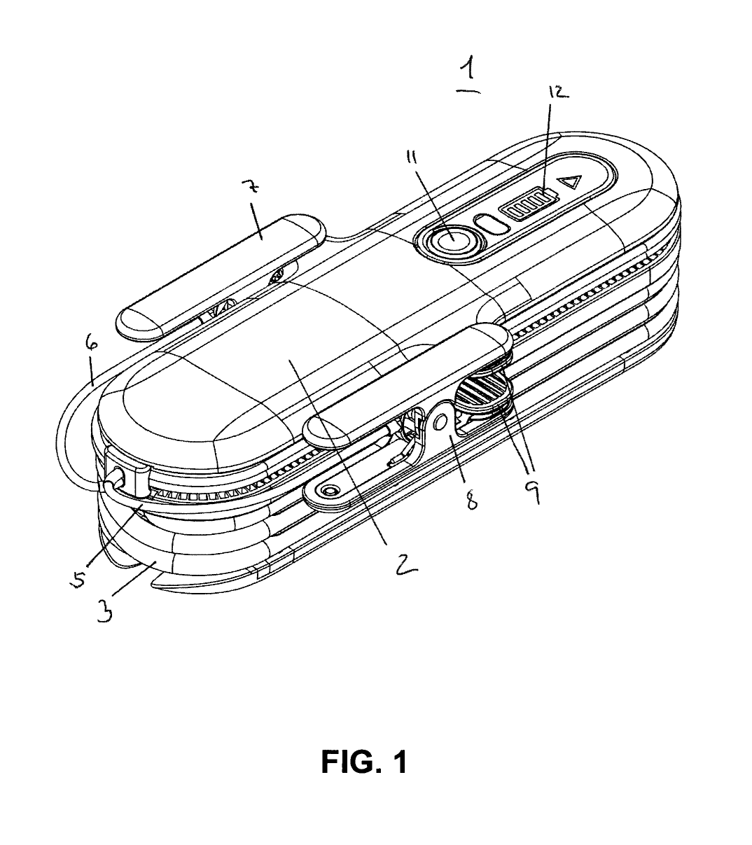

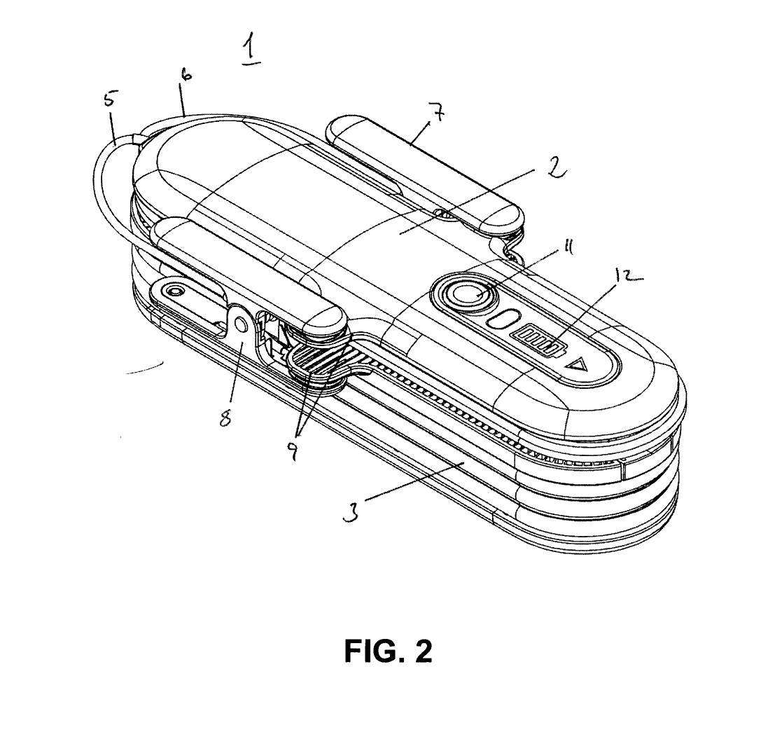

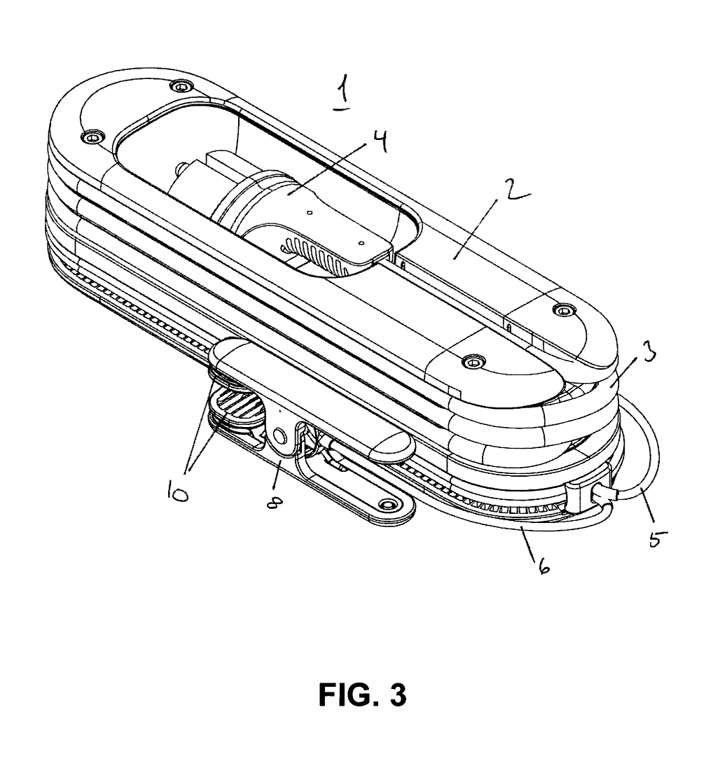

FIGS. 1-3 show a charging device according to the present invention, seen in perspective from different directions.

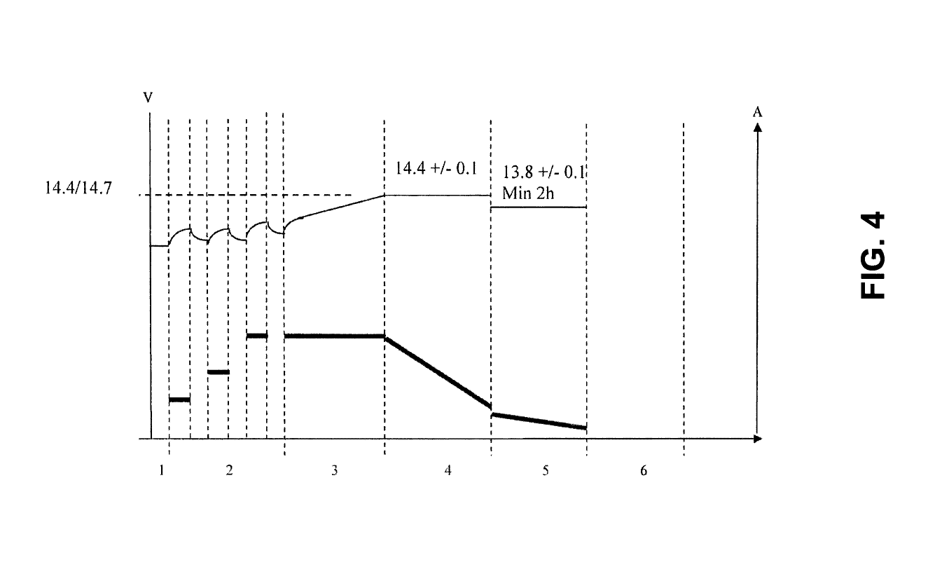

FIG. 4 shows an example of a typical course of charging at a charge current of 4 A.

An embodiment of the charging unit according to the present invention is shown in the FIGS. 1-3.

The charging unit, referred to as 1, comprises a housing 2, connected to said housing 2 is a mains cable 3 with a plug 4 for connection to a mains socket, and two cables 5, 6, for connection to respective battery poles. The cables 5, 6 are connected to their own clamping device 7, 8. The clamping devices 7, 8 are shaped so that they can engage with respective poles on a battery. Furthermore, the clamping devices 7, 8 are formed so that they can be fastened to respective holding means 9, 10 on the housing 2 when the charging unit 1 is not in use. Each holding means 9, 10 comprises two protruding elements, to which elements respective clamping devices can be fastened when the device is not in use. The cable 3 for connection to the mains is coiled around the periphery of the housing 2 and the plug 4 is placed in a recess in the housing 2 when the device is not in use. The coil paths of the cable 3 for connection to the mains and the cables 5, 6 for connection to the battery are, in the main, in parallel and axially displaced with respect to each other.

This means that the device will be very compact and all cables will be kept in place when the device is not in use, so that it is simple to store the device and it will be very simple to remove the cables and the clamping devices when the charging unit is to be used.

Furthermore, a switch 11 is arranged on the housing 2 with which the charging unit can be activated. Furthermore, the charging unit 2 is fitted with an indicator 12 that shows the operating state of the charging device.

Furthermore, an electronic unit (not shown) is placed in the housing 2 that measures/senses the type of battery which is to be charged, controls the charging process and switches off the device after the charging is completed.

The electronic unit will automatically detect the size of the battery (battery capacity) and find a suitable charge voltage. Furthermore, the surrounding temperature will be detected and the electronic unit will compensate the charge voltage accordingly.

The charging device can be used for batteries with a capacity of 4-225 Ah and battery types that can be charged with the help of the device are open and closed lead batteries, so called AGM batteries and gel batteries.

The charging device according to the invention functions as follows:

The charger is connected to the battery that is to be charged with the help of the clamping devices 8, 9 and the plug 4 is placed in a wall socket or the like, which supplies a voltage of 230V. The charging commences when the switch 11 is activated. The charging device can also be used as a current supply for a limited period, and this time period is determined by the electronic unit.

### EXAMPLE

A typical course of charging at 4 A is shown in FIG. 4.

The X-axis gives the different steps described below, while the Y-axis gives the current in A.

| Charging step | 4 amp |
|---|---|
| 1) Analyse the | Measure the voltage at I = 0 |
| state | 1 second |
| | 5 sec. |
| | Batt. Stat. ind. Time |
| 2) Soft start | Start charging at constant current |
| Find battery size | 1, 2, 4 A measure voltage |
| (Ah capacity) | Increase current if ΔV < 0.2 V |
| | 15 sec on (always wait 15 sec to the |
| | next current level) 15 sec off × 3 |
| | If ΔV >= 0.2 V charge directly with |
| | existing current 1-2-4 A |
| 3) Main charging | Start main charging at correct current |
| | level according to battery size. |
| | Max time 4 amp 12 h |
| | 2 amp 8 h |
| | 1 amp 2 h |
| 4) Top charging | Constant. Voltage 14.4 V until I < 1A |
| | Max time 4 amp 6 h |
| | 2 amp 4 h |
| | 1 amp 3h |
| 5) Maintenance | 13.8 V min at 4 h max 24 h from step 1 |
| charging | |
| 6) Analyse | Turn off charging measure voltage |
| 7) Rest mode | Rest until next week |
| | If Vbat < 12.7 V go to step 8 |
| 8) Waking | Waking, start new charge cycle |

In this embodiment example the indicator comprises five LED lamps and one warning lamp. These will give the user the following indications:

Step 0 Check output charge line
1^{st} the crocodile
2^{nd} the 12 V plug

Step 1 Analyse
Start timer counter
Measure battery voltage
Indicate battery status green light

| | |
|---|---|
| >12.65 V | all five segments light up |
| 12.55 V-12.65 V | four segments light up |
| 12.45 V-12.55 V | three segments light up |
| 12.35 V-12.45 V | two segments light up |
| 3.5 V-12.35 V | one segment lights up |

<3.5 V Error mode Warning Triangle red light

Step 2 Soft Start
LED indication
1 amp: one LED blinking
2 amp: two LEDs blinking
4 amp: three LEDs blinking

Step 3 Main Charge
1^{st}, 2^{nd}, 3^{rd} LEDs/charging indication
If battery not connected the warning light will light up.
If wrong polarity the warning light will light up.

Step 4 Top Charge
1^{st}, 2^{nd}, 3^{rd}, 4^{th} LEDs/charging indication

Step 5 Maintain charge
All five segments light Green (no blinking)
After 24 h Go to sleep I=0 A Step 7
All segments pulsing from low to high intensity.
2 sec increase intensity
Turn off 1 sec
and so on

Step 6 Analyse
^{st}, 2^{nd} 3^{rd}, 4^{th}, 5^{th} LEDs/charging indication
Measure the voltage after 2 mins. I=0 A

| | |
|---|---|
| If Vbat > 13.0 V after 2 mins OK | Go to step 6 |
| If Vbat < 13.0 V after 2 mins OK | Go to Error RED warning |

turns on (no blinking)

Step 7 Sleep
No special indication

Step 8 Wake up
Go to Step 1 for new charging cycle.

14.7 V Button

1. A charging device for charging of lead batteries and other rechargeable battery types, the charging device comprising:
a housing (2) with a transformer;
cable with a plug for connecting to a mains socket;
a plurality of power cables for supply of electric power to a battery;
a plurality of clamping devices for connection to poles of a battery;
a switch for activation and deactivation of the charging device;
at least one visual indicator configured to provide a user an indication of a charging progress;
wherein the housing is configured such that the cables and the plug are completely or partly lying inside the housing; and the
wherein the plurality of clamping devices are fastened to a plurality of holding means that protrude from the housing when the charging device is not in use;
wherein each holding means of the plurality of holding means encompasses two protruding elements; and
wherein the plurality of power cables for connection to the battery are coiled around a circumference of the housing between each of the two protruding elements of the respective holding means.

2. The charging device according to claim 1, wherein the cable is coiled around a periphery of the housing and that the plug is placed in a recess in the housing when the charging device is not in use.

3. The charging device device according to claim 1, wherein a path of the coiling of the cable with the plug and the plurality of power cables for connection to the battery are, in the main, in parallel and axially displaced in relation to each other.

4. The charging device device according to claim 1, wherein the charging device further incorporates an electronic unit that measures/senses at least one of a type of battery that is to be charged, surrounding temperature and a capacity of the battery.

5. The charging device device according to claim 3, wherein the electronic unit controls a charging voltage and the charging process as a function of measured parameters.

6. The charging device device according to claim 1, wherein the charging device encompasses the at least one visual indicator that gives the user a visual indication of the charging process.

7. The charging device device according to claim 1, wherein the charging device is adapted to charging of at least one of open and closed lead batteries, AMG batteries and gel batteries with a capacity of 4-225 Ah.

8. The charging device device according to claim 1, wherein the at least one visual indicator comprises at least one LED.
